(19) United States
(12) Patent Application Publication
(10) Pub. No.: US 2003/0136394 A1
(43) Pub. Date: Jul. 24, 2003

(54) Dicing saw having an annularly supported dicing blade

(75) Inventors: David B. Blair, Blue Ridge, TX (US); Leon Stiborek, Dallas, TX (US); Paul J. Hundt, Garland, TX (US)

Correspondence Address: TEXAS INSTRUMENTS INCORPORATED, P O BOX 655474, M/S 3999, DALLAS, TX, 75265

(73) Assignee: Texas Instruments Incorporated, Dallas, TX

(21) Appl. No.: 10/230,540

(22) Filed: Aug. 29, 2002

Related U.S. Application Data
(60) Provisional application No. 60/349,589, filed on Jan. 18, 2002.

(51) Int. Cl. B28D 1/04

(52) U.S. Cl. 125/13.01

(57) ABSTRACT

An improved dicing wheel configuration is described herein. In one embodiment, the dicing wheel comprises: a hub, a blade, and an annular support. The hub is mounted on a shaft, and it clasps the blade. The annular support is compressed against the blade by the hub, and it has an outer diameter intermediate the outer diameters of the hub and the blade. A second annular support may also be compressed against the blade on the opposite side from the first annular support, and the annular support(s) may be separable from or bonded to the blade. The improved configuration preferably provides sufficient clearance for the hub to pass over solder bumps, stacked dies, or other protrusions on the wafer. The invention further contemplates methods for forming and using such a dicing wheel, as well as chips cut using such a dicing wheel.

### CROSS-REFERENCE TO RELATED APPLICATIONS

The present application claims priority to Provisional U.S. Patent Application No. 60/349,589, which was filed Jan. 18, 2002, and entitled “High Exposure Shim Supported Wafer Dicing Blade” by inventors D. Blair, L. Stiborek, and P. Hundt.

### BACKGROUND

1. Field of the Invention

This invention generally relates to systems and methods for cutting thin, brittle materials. More specifically, this invention relates to an improved dicing blade for cutting materials such as wafers containing integrated circuits.

2. Description of Related Art

Integrated circuits are generally constructed on crystalline semiconductor substrates shaped as thin, circular wafers. A number of semiconductors can be used; however, doped silicon is by far the most popular semiconductor substrate. Although the cost of the silicon dioxide used to prepare the silicon wafer is relatively low, the process for preparing a highly pure, properly-doped crystalline silicon wafer is both slow and expensive. As a result, the semiconductor industry has invested significant effort in efficient use of the silicon substrate. Integrated circuits are multilayer electronic devices built on the surface of the wafer substrate through a series of cleaning, patterning, etching, deposition, and annealing operations. These steps serve to construct the functional features of the device, layer by layer. The surface area required by a given integrated circuit is a function of both the complexity of the design—i.e., the number and arrangement of individual transistors, capacitors, resistors and other electronic circuit elements-and the dimensions of each electronic element. In general, the footprint of individual integrated circuits is much smaller than the surface area of the wafer; consequently, a single wafer can generally yield multiple—often even thousands—of integrated circuits.

Integrated circuits are conventionally prepared using wafer-level processing techniques, meaning that the semiconductor processing steps necessary to produce functional circuits—i.e., the cleaning, patterning, etching, deposition, and annealing operations—are performed on an entire wafer. This is generally accomplished using repeating patterns of rectangularly-shaped circuits arranged as closely as feasible in a rectangular array on the wafer surface. Because of the resemblance to city maps, the spaces between devices are commonly termed “streets.” The streets are sacrificial area reserved for cutting the wafer into chips, each chip containing an individual integrated circuit. Cost effective silicon substrate use and wafer level processing requires that a single wafer yield as many usable integrated circuits as possible, which requires—among other things—minimizing the width of the streets.

The arrangement of chips on the wafer surface and the corresponding streets are depicted in FIG. 1. The single crystal wafers 11 used in semiconductor processing are not perfectly circular and instead have a flat portion 12 that allows proper orientation of the wafer crystal structure during processing and separation procedures. The integrated circuits 13 constructed on the wafer 11 are separated from one another by the grid of streets 14. As is evident from FIG. 1, usable wafer surface area is reduced both by the number and width of the streets and by the area mismatch at the periphery of the wafer that results in partial, non-functional devices 15. The smaller the footprint of the integrated circuit, the less significant are the losses in usable surface area at the wafer periphery. In many cases, the dominant cause of lost surface area can be due to the streets.

Recent processing improvements emphasize the importance of narrowing the streets and reducing the loss of usable surface area attributable to them. Each year, technological advances allow the reduction of individual electronic element dimensions and the overall miniaturization of integrated circuits. The net result is that each year, for a given chip design, the number of devices that can be placed on a given size wafer increases. As the number of chips on a wafer increases, so too do the number of streets necessary to separate the individual chips from one another. Stated differently, as the number of integrated circuits on a wafer increases, so too does the loss in usable silicon surface area for a given street width. Not surprisingly, significant effort has been directed toward minimizing the width of the cut, which is referred to as the kerf, so as to maximize the usable wafer surface area.

Following the processing steps, the individual ICs, which are frequently referred to as chips or die, must be separated from one another, bonded to metal leads, and packaged in an appropriate ceramic or plastic housing. Acceptable die separation techniques must not only minimize the loss of usable wafer surface area by providing narrow streets, but must also be highly accurate and precise, versatile and cost efficient. Given these stringent requirements, the list of feasible separation techniques is short: promising alternatives include mechanical sawing and scribing, chemical etching, and laser cutting.

Mechanical sawing provides a number of advantages and is the most popular die separation technique. Sawing allows precise and accurate control over cut location and depth. Consequently, sawing can be used to cut either partially or completely through the wafer. In addition, sawing provides control over surface finish and is economically attractive.

Sawing operations utilize specially-designed dicing saws that can cut partially or completely through the wafer substrate along the rectangular grid, or streets, defined by the individual die. Dicing saws utilize an abrasive machining process similar to that used in various industries for decades: a circular abrasive blade rotating at high speeds cuts through the wafer substrate. FIGS. 2A and 2B show a device, referred to herein as a dicing wheel, for making high-precision cuts of semiconductor wafers. The dicing wheel is typically part of a larger machine that receives material on a flat “table” surface 103 and traverses the material with the dicing wheel on command or at regular intervals. The dicing wheel of FIG. 2 is secured on a shaft 104 by a nut 106. A blade 108 is held between two portions of a hub 110. The entire assembly typically rotates between 35,000 and 45,000 rpm.

The blade typically consists of diamond grit embedded in a thin aluminum matrix, although other suitable blade materials exist. The blade thickness can vary, but typically is between 15 and 140 microns (μm). The diameter can vary similarly, but typically is between about 5 and 10 centimeters (cm). The hub diameter is typically about ninety-eight percent of the blade diameter. Thus, in a typical arrangement, only the outer 125 to 1250 microns (μm) of the blade is exposed and unsupported. This is necessary to provide adequate tensile strength and rigidity for the blade. Although two-piece hub construction is common, single-piece hub designs may also be used. In one variation, one portion 110 of the hub is a permanent flange on shaft 104, and the other portion 110 is bonded to the blade 108. Such “hub blades” may be purchased as a single unit from blade manufacturers.

These dicing saws allow control over the width of the cut, or kerf, through proper blade selection: thinner blades provide narrower streets. However, blade strength imposes fundamental limitations on the minimum kerf that can be achieved. Thinner blades have inherently lower structural integrity and are more prone to breakage. As a general rule in the semiconductor separation and packaging industry, the blade thickness must be at least one tenth the length of the exposed and unsupported portion of the blade.

FIG. 3 shows a magnified, cross-sectional view of a wafer 202 being cut by a dicing wheel blade 108. An adhesive backing 206 is usually attached to the wafer 202 to hold the chips in place during the cutting process. In some integrated circuit designs—e.g., a “flip chip” configuration—the manufacturing process includes the addition of solder bumps 204 to the devices. These solder bumps may be 80-100 μm high, and are generally positioned near the edges of the device. Flip chip and other similar configurations that require wafer surface protrusions (copper studs, silver studs, wire loops, stacked dies) are problematic.

For such designs, either the streets must be made wide enough to keep the hub 110 from damaging or removing the surface protrusions 204 or the exposed and unsupported portion of the blade must be increased to provide the additional clearance for the hub. Increasing the blade exposure causes inability to dice a wafer due to premature blade loss and reduced device yield. What is needed is a new wafer saw and blade design that minimizes street width without requiring unnecessary blade exposure for “flip chip” and other similar integrated circuit designs that employ raised surface protrusions, stacked die features, or high aspect ratio packages.

### SUMMARY

Accordingly, there is described herein a dicing saw having an improved dicing wheel configuration. In one embodiment, the dicing wheel comprises: a hub, a blade, and an annular support. The hub is mounted on a shaft, and it clasps the blade. The annular support is located between the blade and the hub, and it has an outer diameter intermediate between the outer diameters of the hub and the blade. A second annular support may also be provided on the opposite side of the blade from the first annular support, and the annular support(s) may be separable from or bonded to the blade. The improved configuration preferably minimizes the exposed and unsupported portion of the saw blade while providing sufficient clearance for the hub to pass over solder bumps, stacked dies, or other protrusions on the wafer. The preferred embodiments further include methods for forming and using such a dicing wheel, as well as chips cut using such a dicing wheel.

### BRIEF DESCRIPTION OF THE DRAWINGS

A better understanding of the present invention can be obtained when the following detailed description of the preferred embodiment is considered in conjunction with the following drawings, in which:

FIG. 1 is an example of integrated circuit layout on a wafer;

FIG. 2A is a cross-sectional view of a representative dicing wheel;

FIG. 2B is a side view of the representative dicing wheel;

FIG. 3 is a magnified cross-sectional view of a wafer being cut by the representative dicing wheel;

FIG. 4A is a cross-sectional view of a dicing wheel with annular supports for the blade;

FIG. 4B is a side view of the dicing wheel with annular supports for the blade;

FIG. 5 is a magnified cross-sectional view of a wafer being cut by the dicing wheel with annular supports for the blade;

FIG. 6 is a magnified cross-sectional view of an alternate dicing wheel embodiment cutting a wafer; and

FIGS. 7 and 8 are cross-sectional views of stacked-die wafers being cut by a dicing wheel with annular supports for the blade.

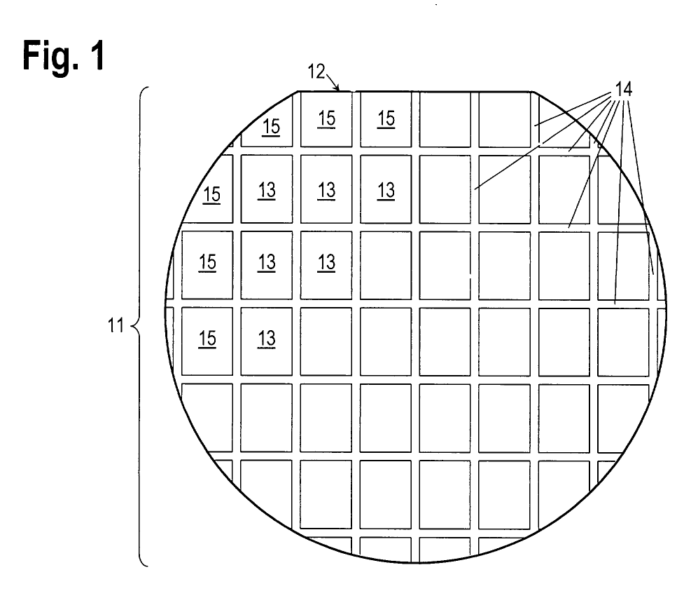

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION

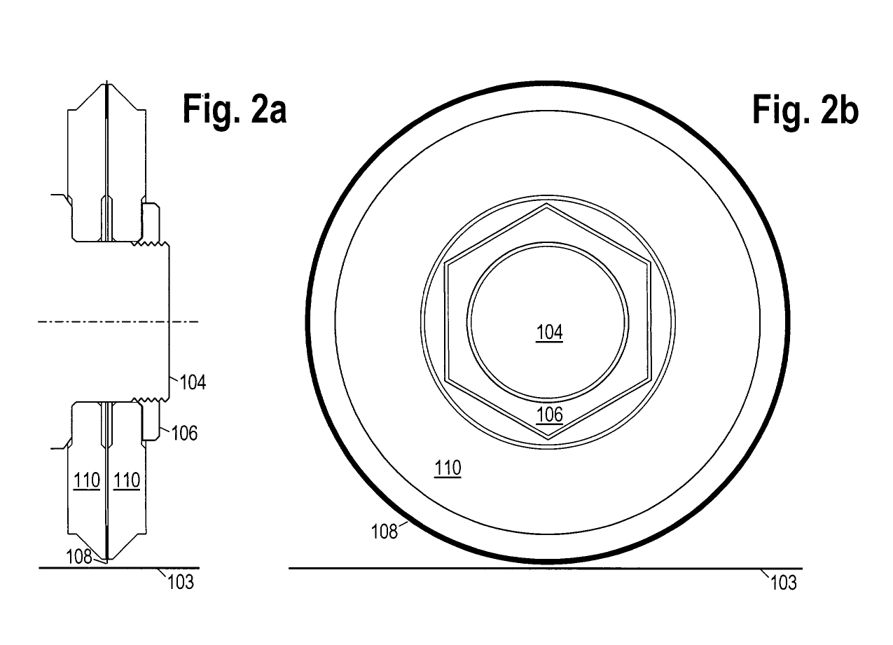

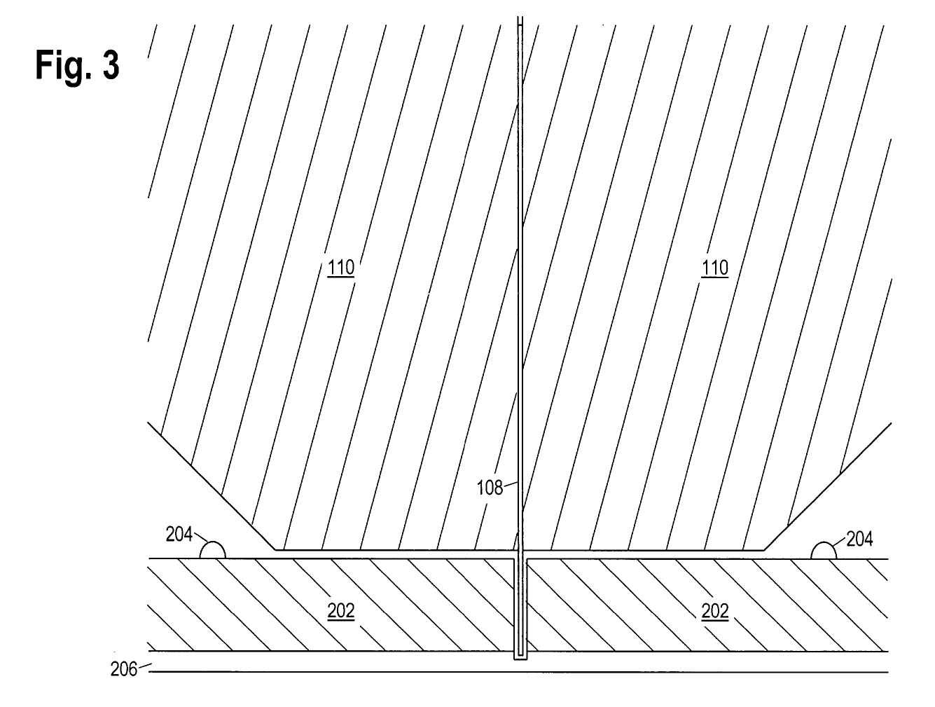

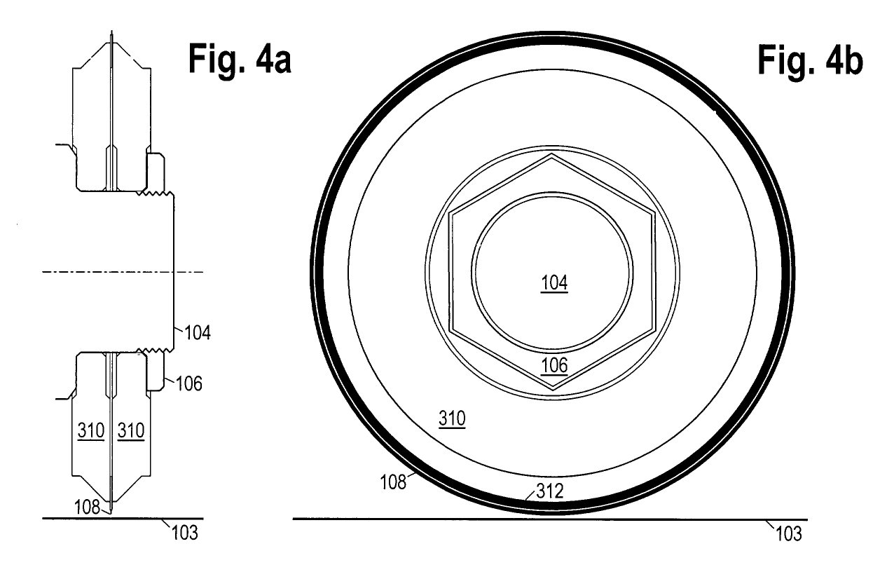

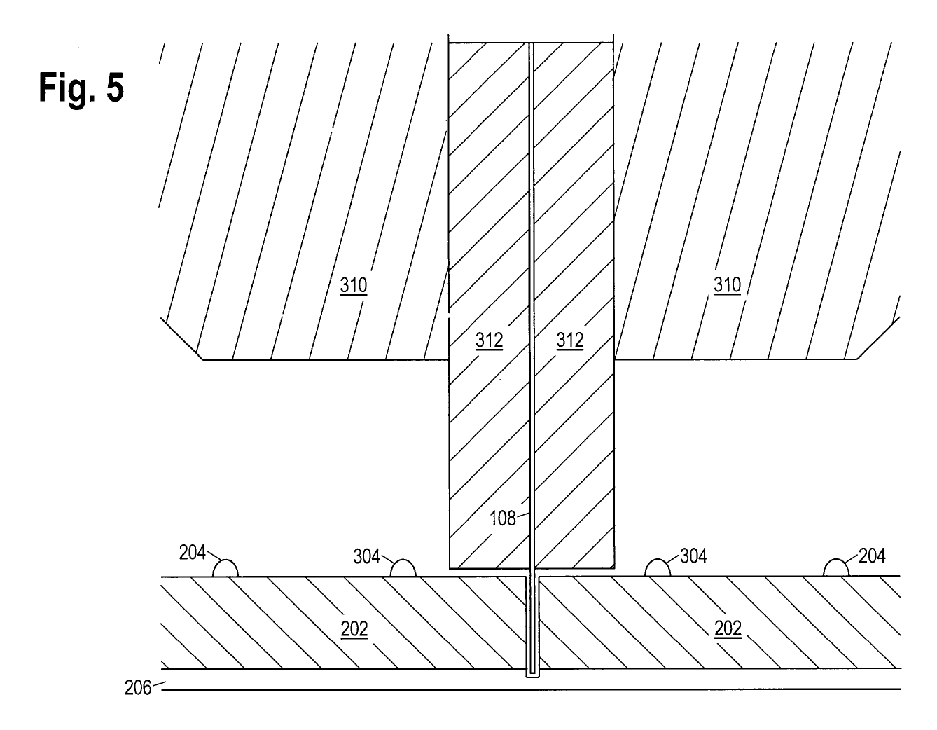

FIGS. 4A and 4B show an improved dicing wheel configuration. Much like the dicing wheel configuration of FIGS. 2A and 2B, the improved dicing wheel has a blade 108 held between two hub portions 310 on a shaft 104. However, the diameter of the hub portions 310 is less than that of hub portions 110, and at least one annular support 312 has been added to maintain the rigidity of blade 108. The annular support(s) 312 are preferably compressed against the blade 108 by the hub portions 310. Although a two-piece hub construction is preferred, alternate constructions are contemplated and are within the scope of the claims. For example, the hub may be a single piece design that surrounds the blade and annular supports. Alternatively, hub portion may take the form of a permanent flange on shaft 104. The blade may be bonded to one or both of the annular support(s) and/or bonded to one hub portion.

The hub portions are preferably made of stainless steel, although other suitable materials exist and may alternatively be used. The dimensions of a hub portion 310 may preferably be about 0.5 cm thick and about 4 to 10 cm in diameter.

The annular support 312 is preferably made of stainless steel, although other suitable materials exist and may alternatively be used. Examples of suitable alternative materials include (but are not limited to) composite materials, organic laminates, and epoxies. These materials can provide the desired rigidity with relatively little thickness, and may advantageously dissipate any harmonic energies that tend to distort the blade and widen the kerf. The annular support may be bonded to the blade, but is preferably unbonded and hence may be re-usable.

The annular support may have any suitable inner diameter, and the outer diameter is determined by the desired exposure of the blade 312. (The exposure is the radial distance by which the blade extends beyond the annular support.) The annular support preferably has a rectangular cross-section, and the thickness of the annular support is preferably no greater than the difference between the outer diameters of the hub and the blade. Of course, the preferred cross-section may have small radiuses or bevels on the corners, and may be subject to standard manufacturing tolerances. In addition, the thickness of the annular support is preferably as small as feasible, and would desirably be about one tenth of the difference in outer radii of the hub and the annular support.

The blade 108 is preferably made of diamond grit embedded in a thin aluminum matrix, although other suitable materials exist and may alternatively be used. Examples of other suitable matrix materials may include (but are not limited to) copper, brass, and/or nickel. A variety of blade thicknesses and exposures may be provided, conventionally ranging from about 15 to 140 μm in thickness and from about 125 to 1250 μm in exposure.

FIG. 5 shows a magnified cross-section of an improved dicing wheel as it cuts a wafer 202. An adhesive backing 206 is attached to the wafer to hold the chips in place during the cutting process. Solder bumps 204 are shown in positions corresponding to a minimum street width for the dicing wheel of FIG. 3, and solder bumps 304 are shown in positions corresponding to a minimum street width for the improved dicing wheel configuration. For the given configuration, the total street width has been reduced without any increase in the blade exposure.

The thickness of the dicing blade in FIG. 5 is about 40 μmm, and the thickness of each annular support may be equal to or greater than the blade thickness. The annular support thickness is preferably between about 100 to 250 μm. The difference in diameters of the blade and the annular supports is about 0.9 mm. The difference in diameters of the annular supports and the hub is about 3 mm, although an amount slightly greater than the twice the expected maximum protrusion height would be sufficient.

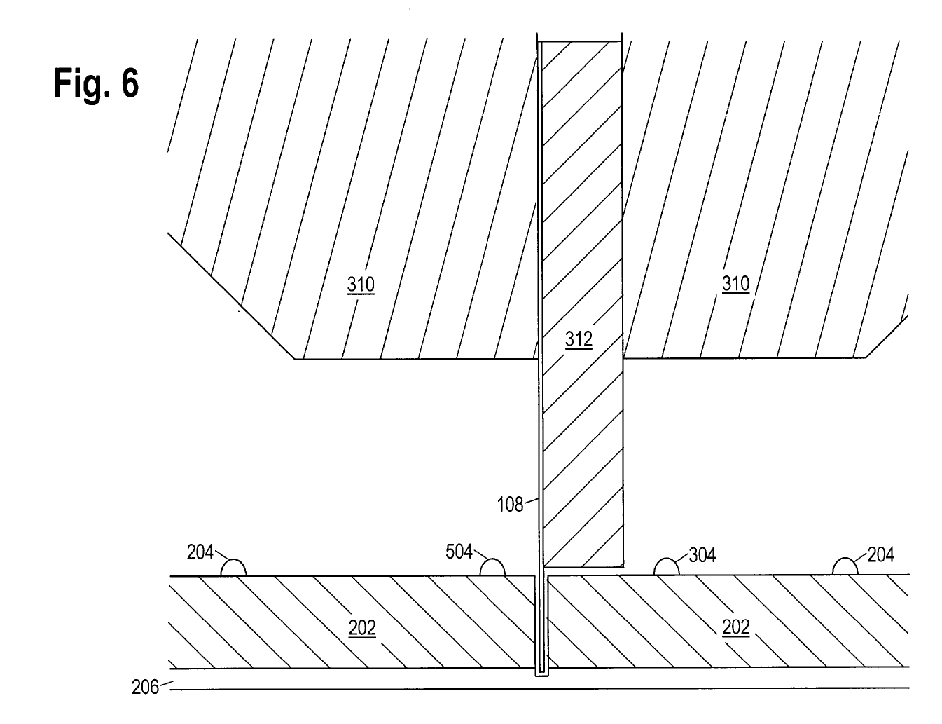

FIG. 6 shows a magnified cross-section of an alternate embodiment in which only one annular support 312 is used. In this instance, the annular support is preferably bonded to the blade 108. As demonstrated by the placement of solder bump 504, additional reduction of street widths may be achievable in this manner without concurrent loss of blade life.

The improved dicing wheels are formed in one of several manners. Preferably, one or more annular supports are placed adjacent the blade, and hubs are provided to compress the annular support(s) against the blade. The hub, annular support(s) and blade are mounted on a shaft, and a nut may be provided to secure the assembly and to provide the compressive force.

The improved dicing wheels are employed in the same manner as described previously in the background. Namely, the wafer or other material to be cut is received on a flat surface 103, which is then traversed by the improved dicing wheel. The annular supports provide adequate clearance between the material and the hub to prevent damage, abrasion or removal of bumps on the surface.

Advantageously, integrated circuit chips cut with an improved dicing wheel may have thinner margins on edges with nearby solder bumps. Narrower streets may allow for more integrated circuits to be imprinted on each wafer, which would reduce wasted wafer space and increase economic efficiency of the chip manufacturing process.

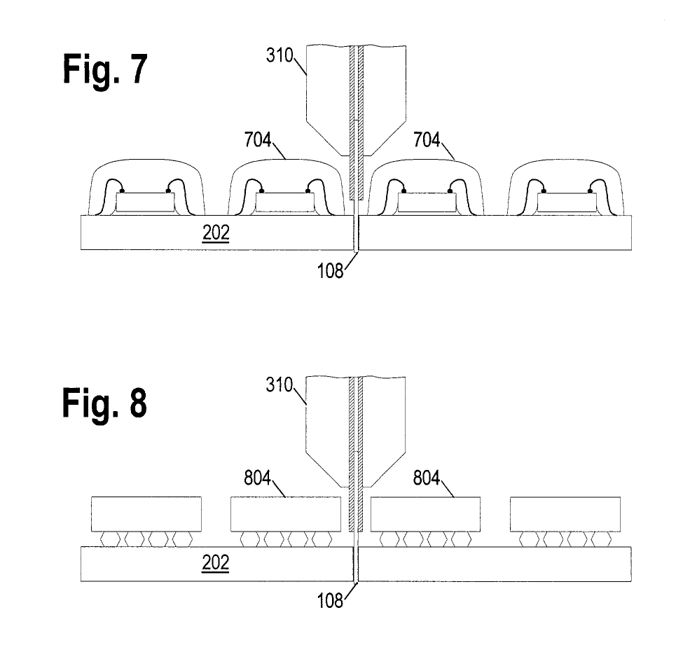

FIG. 7 shows a cross-section of a wafer 202 having a stacked-die configuration. In the configuration shown, the surface protrusions 704 are encapsulated dies that are glued and wire-bonded to the wafer 202. The wires serve to connect the circuits imprinted in the encapsulated dies to the circuits imprinted in the wafer. FIG. 8 shows a cross-section of a wafer 202 having a different stacked-die configuration. In this configuration, the surface protrusions 804 are flip-chips that are bonded to the wafer 202. In both FIGS. 7 and 8, the use of annular supports allows the dicing wheel to traverse much narrower streets than would otherwise be required for dicing. It is noted that the dicing wheel could also be used to separate packages after their assembly with the integrated circuit dies.

Numerous variations and modifications will become apparent to those skilled in the art once the above disclosure is fully appreciated. It is intended that the following claims be interpreted to embrace all such variations and modifications.

What is claimed is:

1. A method of dicing semiconductor wafers, the method comprising:
placing a semiconductor wafer on a surface; and
traversing the semiconductor wafer with a dicing wheel having a blade compressed between annular supports by a dicing wheel hub.

2. The method of claim 1, wherein the annular supports are not bonded to the blade.

3. The method of claim 2, wherein the annular supports have a rectangular cross-section.

4. The method of claim 3, wherein the annular supports have a combined width that is no greater than a difference between outer diameters of the hub and the blade.

5. The method of claim 4, wherein the outer diameter of the blade minus an outer diameter of the annular support is at least 1 mm, and wherein the blade has a thickness less than about one fifth of this difference.

6. The method of claim 4, wherein the annular support has an outer diameter greater than the outer diameter of the hub by at least twice an expected protrusion height on the wafer.

7. The method of claim 4, wherein the annular support is made of a composite material.

8. A method of dicing semiconductor wafers, the method comprising:
placing a semiconductor wafer on a surface; and
traversing the semiconductor wafer with a dicing wheel having a blade bonded to an annular support and mounted on a dicing wheel hub.

9. The method of claim 8, wherein the annular supports have a rectangular cross-section.

10. The method of claim 9, wherein the annular supports have a combined width that is no greater than a difference between outer diameters of the hub and the blade.

11. The method of claim 10, wherein the outer diameter of the blade minus an outer diameter of the annular support is at least 1 mm, and wherein the blade has a thickness less than about one fifth of this difference.

12. The method of claim 10, wherein the annular support has an outer diameter greater than the outer diameter of the hub by at least twice an expected protrusion height.

13. The method of claim 10, wherein the annular support is made of a composite material.

14. A method of cutting thin materials having narrow street widths, the method comprising:
placing the thin material on a surface; and
traversing the thin material with a dicing wheel having a blade compressed between annular supports by a dicing wheel hub,
wherein the annular supports have a combined width that is no greater than a difference between outer diameters of the hub and the blade.

15. A method of forming a dicing wheel, the method comprising:
sandwiching a blade between annular supports; and
placing the blade and annular supports between hub components on a shaft, wherein the blade has an outer diameter that is no more than about 10% greater than an outer diameter of the hub components, and wherein the annular supports have an outer diameter between the outer diameters of the hub and the blade.

16. A chip formed by:
imprinting circuits on each of multiple portions of a wafer; and
separating the multiple portions with a dicing wheel having a blade compressed between annular supports by a dicing wheel hub.

17. A semiconductor dicing saw that comprises:
a surface that receives a semiconductor wafer;
a dicing wheel that traverses the semiconductor wafer, wherein the dicing wheel includes:
a hub;
a blade secured to the hub; and
an annular support between the hub and the blade, wherein the annular support has an outer diameter intermediate those of the hub and the blade.

18. The dicing saw of claim 17, wherein the blade has an outer diameter that is no more than about 10% greater than an outer diameter of the hub.

19. The dicing saw of claim 18, further comprising:
a second annular support compressed between the hub and the blade on a side of the blade opposite the first annular support.

20. The dicing saw of claim 17, wherein the annular support is bonded to the blade.

21. The dicing saw of claim 17, wherein the annular support is not bonded to the blade.

22. The dicing saw of claim 18, wherein the annular support has a rectangular cross-section.

23. The dicing saw of claim 18, wherein tile annular support has a width that is no greater than a difference between the outer diameters of the hub and the blade.

24. The dicing saw of claim 18, wherein the outer diameter of the blade minus the outer diameter of the annular support is at least 1 mm, and wherein the blade has a thickness less than about one fifth of this difference.

25. The dicing saw of claim 18, wherein the outer diameter of the annular support is greater than the outer diameter of the hub by at least twice an expected wafer surface protrusion height.

26. The dicing saw of claim 17, wherein the annular support is made of one or more materials selected from a group consisting of stainless steel, a composite, an organic laminate, and an epoxy.

27. A stacked chip formed by:
imprinting circuits on each of multiple portions of a wafer;
stacking one or more diced dies and interconnecting the one or more diced dies to the imprinted circuits in corresponding portions of the wafer; and
separating the multiple portions with a dicing blade compressed between annular supports.

28. An integrated circuit package formed by:
assembling multiple dies onto corresponding portions of a substrate material; and
separating the portions with a dicing wheel having a blade compressed between annular supports.
